(19) United States
(12) Patent Application Publication
(10) Pub. No.: US 2017/0215584 A1
(43) Pub. Date: Aug. 3, 2017

(54) STEMWARE RACK

(71) Applicant: Robinson Home Products Inc., Williamsville, NY (US)

(72) Inventors: Lou Henry, Scarsdale, NY (US); John Healy, Brooklyn, NY (US)

(21) Appl. No.: 15/408,030

(22) Filed: Jan. 17, 2017

Related U.S. Application Data
(60) Provisional application No. 62/289,619, filed on Feb. 1, 2016.

(51) Int. Cl. A47B 81/04; A47J 47/16; A47B 43/00

(52) U.S. Cl. CPC A47B 81/04; A47B 43/00; A47J 47/16

(57) ABSTRACT

A collapsible stemware rack with a body having a top, a bottom, opposed sides, a first end and a second end, feet members, and stanchion elements between the body and the feet members, the body comprising a substantially horizontal platform with two or more support arms extending orthogonally on each of the opposed sides forming an entry slot for receiving stemmed glasses, and hinge members at the first end and the second end for coupling the stanchion elements to the body and for adapting the rack from a protracted configuration to a collapsed configuration.

### FIELD OF THE INVENTION

The present invention relates generally to kitchen racks, and more specifically to a collapsible stemware rack for holding stemware of suitable shape and sizes.

### BACKGROUND OF THE INVENTION

Stemware typically consists of, without limitation, a glass or a crystal vessel having a rounded bowl mounted on a base by a stem. The bowl is generally of very fragile, thin-walled construction susceptible to breakage and is joined to the stem at a neck portion. The base portion is usually of circular contour, having a diameter often smaller than the diameter of the bowl. The stem portion is often of a length and a diameter that produces a high center of gravity and contributes to an increased propensity of the stemware to tip over.

Storage and drying systems for stemware commonly employ a rack having paired horizontally elongated rails which supports the stemware in an inverted position by slidable engagement with the base portion of stemware. The racks are usually mounted to an overhead support, such as areas under cabinetry or onto an overlying shelf in a kitchen cabinet, and require stemware to be inserted onto a front access extremity of the rack and pushed back over paired rails toward a closed rear extremity. However, the ease of access is greatly impaired with increasing length of the rails that would require items near the rear extremity to travel a substantial distance to the front extremity for removal.

Additionally, stemware may be stored in a common disk rack designed to hold an assortment of kitchen articles or in specialized racks designed to hold individual pieces of stemware. However, these racks are generally bulky and difficult to store and, therefore, can take up a significant portion of kitchen countertop, cabinet, drawer or shelf space relative to their size.

Accordingly, there exists a need for a collapsible stemware rack that securely holds stemware and is compact for ease of storage.

### SUMMARY OF THE INVENTION

The present invention is directed to a collapsible stemware rack comprising a body having a top, a bottom, opposed sides, a first end and a second end, feet members, and stanchion elements between the body and the feet members, wherein the body comprises a substantially horizontal platform with two or more support arms extending orthogonally on each of the opposed sides forming an entry slot for receiving stemmed glasses and hinge members at the first end and the second end for coupling the stanchion elements to the body.

The support arms preferably include a gripping surface region for holding the base of a stemmed article placed thereon. The gripping surface region preferably comprises material of high coefficient of friction for retaining the stemmed glasses on the rack, the material being used for the entire body or as an added element on the support arms. The entry slots are particularly dimensioned and configured to allow substantially unimpeded passage for the stem portion of a stemmed glass toward the body.

The body is maintained and supported at a fixed vertical height, when in a protracted configuration, by stanchion elements that are attached at one end to hinge members at the first end and the second end of the body and at a second end to corresponding feet members. The stanchion elements can comprise a single stanchion element on each of the ends of the body or may comprise two or more stanchion elements on each end. The hinge members allow the stanchion elements and feet members to fold and unfold under the body for the collapsible stemware rack to transition between the protracted and collapsed configurations.

The feet members are dimensioned and configured to provide stable support of the rack on a substantially flat support surface, such as a kitchen countertop. In its preferred embodiment, the feet members comprise a high friction material on the bottom surface of the feet members that contact the support surface when the rack 10 is in the protracted configuration, to prevent sliding of the rack on the support surface.

The collapsed configuration of the collapsible stem rack provides for convenient storage when not in use. To aid in folding the rack, one of the feet members preferably comprises a channel on one side for passage of a portion of the opposed stanchion element, permitting the rack to fold flat when in the collapsed configuration.

### BRIEF DESCRIPTION OF THE DRAWINGS

FIG. 1 is an exploded perspective view of an embodiment of the collapsible stemware rack of the present invention.

FIG. 2 is a perspective view of an embodiment of the collapsible stemware rack of the present invention in its collapsed configuration.

FIG. 3 is a side elevation view of an embodiment of the collapsible stemware rack of the present invention in its collapsed configuration.

FIG. 4 is a front elevation view of an embodiment of the collapsible stemware rack of the present invention in its collapsed configuration.

FIG. 5 is a top plan view of an embodiment of the collapsible stemware rack of the present invention in its collapsed configuration.

FIG. 6 is a top plan view of the body of the collapsible stemware rack of the present invention.

### DETAILED DESCRIPTION

The present invention is now described with reference to figures which indicate identical or functionally similar elements. While specific configurations and arrangements are discussed, it should be understood that this is done for illustrative purposes only. A person skilled in the relevant art will recognize that other configurations and arrangements can be used without departing form the spirit and scope of the invention.

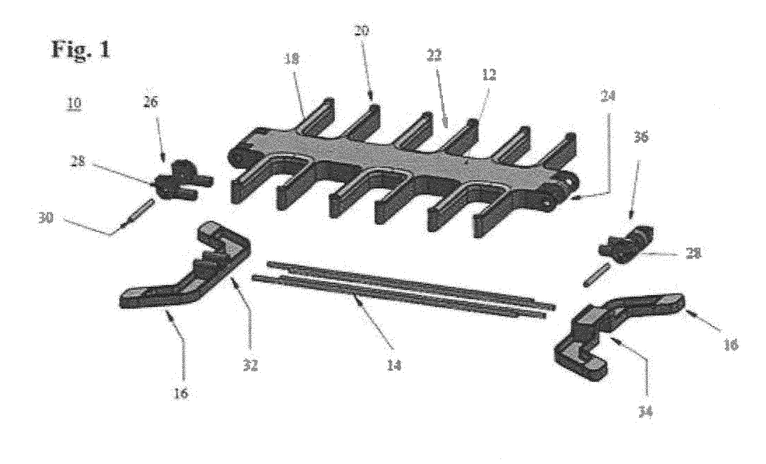

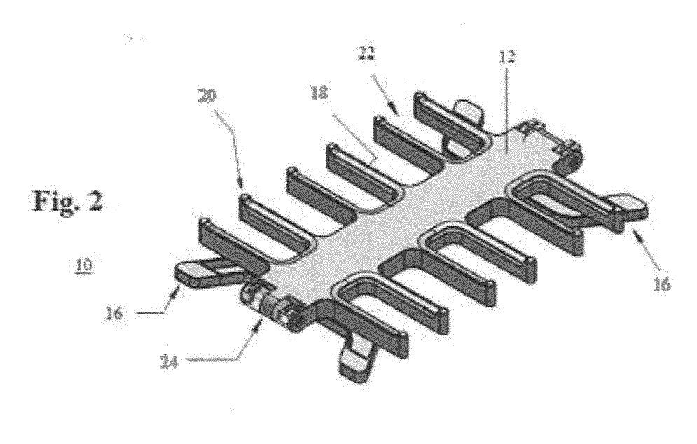

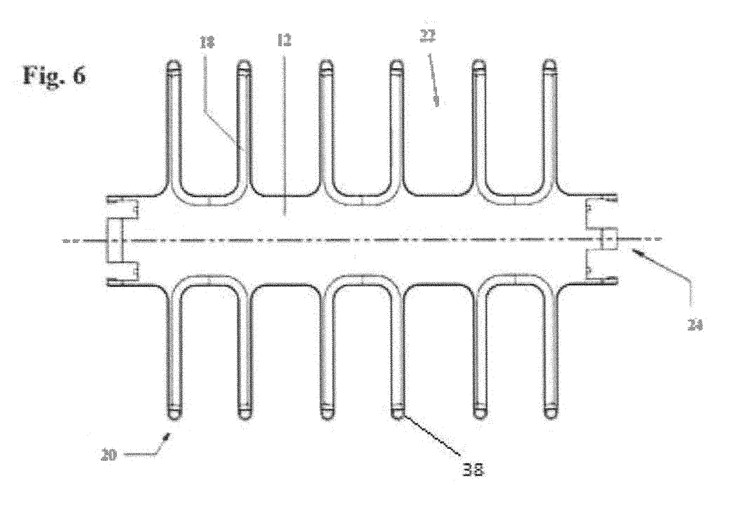

In a preferred embodiment, shown in accompanying FIGS. 1-5, the collapsible stemware rack 10 comprises a body 12 having a first end and a second end, feet members 16, and stanchion elements 14 wherein the body 12 has a plurality of support arms 20 extending orthogonally from the sides of the body 12 at fixed distances between the first end and the second end. The body 12 further comprises hinge members 26 and 36 fixed to hinge sections 24 on the first end and the second end by hinge pins 30 for pivotal attachment of the stanchion elements 14 to the first end and the second end of the body 12.

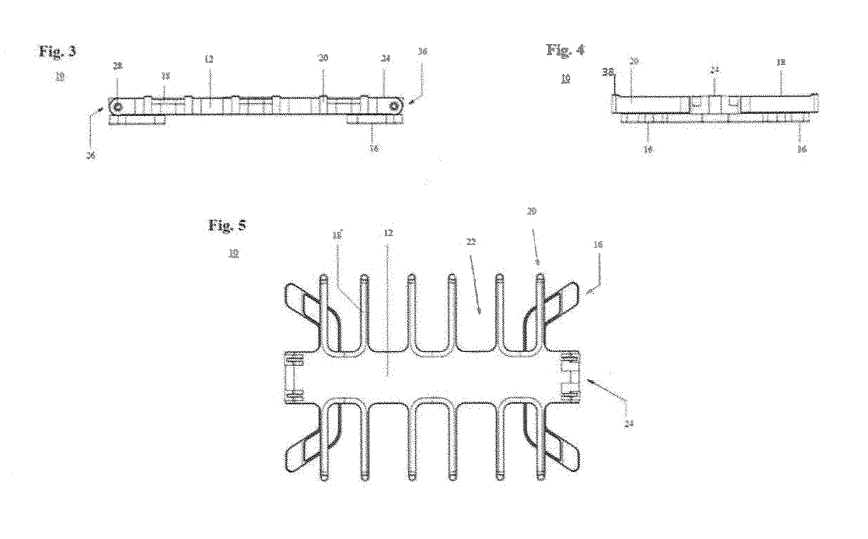

Engagement means 32 attach the stanchion elements 14 to the feet members 16, and may use any suitable attachment mechanism including, but not limited to, screw-in, twist-in, snap-in, clamps, press-fit, or other positive connection means including permanent and removable connections. At least one of the feet members 16 preferably comprises a channel 34 on one side for passage of a portion of the opposed stanchion element 14 which creates a passage for a portion of the opposed stanchion element 14, such that the feet member 16 on the first stanchion 16 does not interfere with the opposed stanchion 16 in the collapsed configuration. The use of such a channel 34 thereby permits the rack 10 to fold flat when in the collapsed configuration (see FIGS. 3 and 4).

The body 12 is adapted to detachably hold an exposed surface portion of the stemware, and preferably the base of the stemware glass. As seen in FIGS. 1, 2 and 5, the body 12 includes a substantially horizontal platform with pairs of support arms 20 on both sides of the body 12. The support arms 20 create entry slots 22 between adjacent support arms 20.

The support arms 20 preferably comprise gripping surface regions 18 on the upper surface of the support arms 20, to maintain a positive grip on the base of the stemware, and a raised distal end 38, to prohibit unintended movement of the stemware off of the end of the support arms 20. In keeping, the gripping surface regions 18 comprise a material with a high coefficient of friction, preferably comprising a thermoplastic rubber (“TPR”), and preferably are placed on the entire top surface of the support arms 20, although the gripping surface region 18 may not be included on the raised distal ends 38.

In the preferred embodiment shown in the accompanying drawings, the collapsible stemware rack 10 has six support arms 20 on each side of the body 12, forming 5 entry slots 22 on each side. It is understood, of course, that the number of support arms 20, and therefore the number of entry slots 22, can be any suitable number. It is also understood that the distance between support arms 20 should be close enough to support the bases of the stemware, while being far enough to permit the bowls of the stemware to fit side by side. Additionally, the length of the support arms 20 may be sufficient to permit the bowls of the stemware to be placed offset within the entry slots 22.

In the protracted configuration, the body 12 of collapsible stemware rack 10 is elevated above the support surface on which the feet members 16 rest to a fixed vertical height that is maintained and supported by the stanchion elements 14. It is understood that any suitable fixed height may be used, with the height of the body 12 above a support surface being determined by the height of the stanchion elements 14, in combination with the feet elements 16. In the preferred embodiment, the stanchion elements and feet members are of a height sufficient to raise the bodyl2 to a vertical height of from about 8 to about 12 inches

In a preferred embodiment, the collapsible stemware rack 10 has a capacity to hold four balloon or six white/flute shaped stemware glasses, up to ten inches in height, in an inverted orientation where the base of the stemware rests on the gripping surface region 18 of the support arms 20, with the stem of the stemware passing within the entry slots 22.

The feet members 16 are similarly adapted to securely receive the second ends of the stanchion elements 14, and may use any suitable attachment mechanism including, but not limited to, screw-in, twist-in, snap-in, clamps, press-fit, or other positive connection means including permanent and removable connections. In the preferred embodiment, the feet members 16 comprise a high friction material, such as a TPR on the bottom surface, to prevent sliding of the rack on the support surface.

The body 12, engagement members 26, 36, stanchion elements 14, and feet members 16 of the collapsible stemware rack 10 may be composed of any suitable substantially rigid and durable material such as glass, stainless steel, aluminum, wood, plastic and combinations thereof. A preferred material for the body 12, engagement members 26, 36, and feet members 16 is plastic, and more preferably an acrylonitrile butadiene styrene (“ABS”). A preferred material for the stanchion elements 14 and the hinge pins 30 is steel, and more preferably stainless steel.

While certain exemplary embodiments have been described and shown in the accompanying drawings, it is to be understood that such embodiments are merely illustrative and not restrictive of the current invention, and that this invention is not restricted to the specific constructions and arrangements shown and described since modification can occur to those ordinarily skilled in the art.

Variations, modifications, and alterations to the above detailed description will be apparent to those skilled in the art. All such variations, modifications and/or alternatives are intended to fall within the scope of the present invention.

The terms “comprising” or “comprises” as used in the following claims are open-ended transitional terms that is intended to include additional elements not specifically recited in the claims.

It should be noted that it is envisioned that any feature or element that is positively identified in this document may also be specifically excluded as a feature or element of an embodiment of the present invention.

1. A collapsible stemware rack comprising:
a body having a top, a bottom, opposed sides, a first end, and a second end, the body further comprising a substantially horizontal platform with two or more support arms extending orthogonally on each of the opposed sides forming an entry slot between adjacent support arms and hinge members at the first end and the second end;
a plurality of feet members; and
a plurality of stanchion elements between the body and the feet members, the stanchion elements being coupled to the hinge members at a first end and the feet members at the second end,
wherein the hinge members permit the stanchion elements and feet members to be pivoted from a protracted configuration for use to a collapsed configuration for storage.

2. The collapsible stemware rack of claim 1, wherein the support arms comprise a gripping surface region on a top surface of the support arms.

3. The collapsible stemware rack of claim 2, wherein the gripping surface region comprises a thermoplastic rubber.

4. The collapsible stemware rack of claim 1, wherein the support arms comprise a raised distal end.

5. The collapsible stemware rack of claim 1, wherein the stanchion elements and feet members are of a height sufficient to raise the body to a vertical height of from about 8 to about 12 inches.

6. The collapsible stemware rack of claim 1, wherein the body is made of acrylonitrile butadiene styrene plastic.

7. The collapsible stemware rack of claim 1, wherein the feet members are formed of a acrylonitrile butadiene styrene plastic.

8. The collapsible stemware rack of claim 1, wherein at least one of the feet members further comprises a channel.

9. The collapsible stemware rack of claim 1, wherein at least one of the feet members comprises a thermoplastic rubber on a bottom surface when the rack is in a protracted configuration.

10. The collapsible stemware rack of claim 1, wherein the stanchion elements are made of a metal.

11. The collapsible stemware rack of claim 1, wherein the stanchion elements are made of stainless steel.

12. The collapsible stemware rack of claim 1, wherein the body comprises six or more support arms on each of the opposed sides, forming five or more entry slots on each of the opposed sides.
